(19) United States
(12) Patent Application Publication
(10) Pub. No.: US 2012/0137254 A1
(43) Pub. Date: May 31, 2012

(54) CONTEXT-AWARE AUGMENTED COMMUNICATION

(75) Inventors: BOB CUNNINGHAM, Pittsburgh, PA (US); DAVID EDWARD LEE, Pittsburgh, PA (US)

(73) Assignee: DYNAVOX SYSTEMS LLC, Pittsburgh, PA (US)

(21) Appl. No.: 13/304,022

(22) Filed: Nov. 23, 2011

Related U.S. Application Data
(60) Provisional application No. 61/417,596, filed on Nov. 29, 2010.

(51) Int. Cl. G06F 3/048

(52) U.S. Cl. 715/835

(57) ABSTRACT

Systems and methods of providing electronic features for creating context-aware vocabulary suggestions for an electronic device include providing a graphical user interface design area having a plurality of display elements. An electronic device user may be provided automated context-aware analysis from information from plural sources including GPS, compass, speaker identification (i.e., voice recognition), facial identification, speech content determination, user specifications, speech output monitoring, and software navigation monitoring to provide a selectable display of suggested vocabulary, previously stored words and phrases, or a keyboard as input options to create messages for text display and/or speech generation. The user may, optionally, manually specify a context.

### CROSS-REFERENCE TO RELATED APPLICATIONS

N/A

### STATEMENT REGARDING FEDERALLY SPONSORED RESEARCH OR DEVELOPMENT

N/A

### PRIORITY CLAIM

This application claims the benefit of priority of previously filed U.S. Provisional Patent Application entitled “CONTEXT AWARE AUGMENTED COMMUNICATION” assigned U.S. Ser. No. 61/417,596, filed on Nov. 29, 2010, and which is fully incorporated herein by reference for all purposes.

### BACKGROUND

The presently disclosed technology generally pertains to systems and methods for providing alternative and augmentative communications (AAC) steps and features such as may be available in a speech generation device or other electronic device.

Electronic devices such as speech generation devices (SGDs) or Alternative and Augmentative Communication (AAC) devices can include a variety of features to assist with a user's communication. Such devices are becoming increasingly advantageous for use by people suffering from various debilitating physical conditions, whether resulting from disease or injuries that may prevent or inhibit an afflicted person from audibly communicating. For example, many individuals may experience speech and learning challenges as a result of pre-existing or developed conditions such as autism, ALS, cerebral palsy, stroke, brain injury and others. In addition, accidents or injuries suffered during armed combat, whether by domestic police officers or by soldiers engaged in battle zones in foreign theaters, are swelling the population of potential users. Persons lacking the ability to communicate audibly can compensate for this deficiency by the use of speech generation devices.

In general, a speech generation device may include an electronic interface with specialized software configured to permit the creation and manipulation of digital messages that can be translated into audio speech output or other outgoing communication such as a text message, phone call, e-mail or the like. Messages and other communication generated, analyzed and/or relayed via an SGD or AAC device may often include symbols and/or text alone or in some combination. In one example, messages may be composed by a user by selection of buttons, each button corresponding to a graphical user interface element composed of some combination of text and/or graphics to identify the text or language element for selection by a user.

Current advancements for speech generation devices have afforded even more integrated functionality for their users. For example, some SGDs or other AAC devices are configured not only for providing speech-based output but also for playing media files (e.g., music, video, multi-media, etc.), providing access to the Internet, and/or even making telephone calls using the device.

As the accessibility and communications functionality of SGDs continues to increase, users need to be able to communicate with enhanced vocabulary and symbol set options. Conventional fixed sources or databases of such communication elements are typically lacking in dynamic development of such elements that could enhance SGD communications functionality.

In light of the specialized utility of speech generation devices and related interfaces for users having various levels of potential disabilities, a need continues to exist for refinements and improvements to context sensitive communications. While various implementations of speech generation devices and context recognition features have been developed, no design has emerged that is known to generally encompass all of the desired characteristics hereafter presented in accordance with aspects of the subject technology.

### BRIEF SUMMARY

In general, the present subject matter is directed to various exemplary speech generation devices (SGDs) or other electronic devices having improved configurations for providing selected AAC features and functions to a user. More specifically, the present subject matter provides improved features and steps for creating context-specific message item choice selections (e.g., for such message items as vocabulary, words, phrases, symbols and the like) for inclusion in composing messages.

In one exemplary embodiment, a method of providing automatic context identification is provided. According to this automatic method, one or more data elements for use in determining a communication context are electronically gathered. Exemplary data elements may correspond to such items as user specification, speaker/voice identification, facial recognition, speech content, GPS/compass data and/or geolocation information. One or more data gathering software modules such as a speaker identification (i.e., voice recognition) module, facial recognition module, GPS data module, compass data module, geolocation information module, speech recognition (i.e., speech content determination) module, bar code data module and user specifications module may be used to for communicator identification and/or location identification.

Selected pieces of the gathered data elements are then electronically analyzed either to determine that a user has manually specified a communications context (e.g., by selecting a preconfigured context within the user specifications module) or to implement the automatic determination of a communication context based on the gathered data elements. In general, the manually or automatically determined communication context provides a profile of a user and/or one or more of the user's communication partners and/or one or more of the locations, speech, device specifications or other related aspects associated with device use.

The specifics of the profile are then used to develop communicator-specific and/or location-specific message items (e.g., words, phrases, symbols, pictures, and other language items) for display to a user for selectable inclusion in messages being composed by the user on an AAC device. Additional message items or other language suggestions may be provided from a local or online search relating to identified items defining a communication context (e.g., determined location, determined communicator name, etc.) Once particular message items are identified for suggestion to a user, such message items may be provided as selectable output to a user. More particularly, such items may be displayed on a screen associated with the AAC device, preferably in an array of scrollable and/or selectable items. The displayed message items ultimately can be used by a user for composing messages for display and/or conversion to synthesized or digital file reproduced speech and/or remote communication to another via text, email, or the like.

In other more particular exemplary embodiments, a communication context data structure is provided that stores not only information identifying a context, but also a history of speech output made in that context and/or a history of software navigation locations made in that context. This additional information can be electronically stored for use by a user. In certain embodiments, GPS and compass information may be used in conjunction with geolocation software for determining physical location and place information to suggest language to use in a particular location context.

It should be appreciated that still further exemplary embodiments of the subject technology concern hardware and software features of an electronic device configured to perform various steps as outlined above. For example, one exemplary embodiment concerns a tangible computer readable medium embodying computer readable and executable instructions configured to control a processing device to implement the various steps described above or other combinations of steps as described herein.

In one particular exemplary embodiment, a tangible computer readable medium includes computer readable and executable instructions configured to control a processing device to analyze faces and/or speech to recognize individual communicators (i.e., the device user and/or communication partners with whom the user is communicating) and to suggest language or other message items appropriate to the identified individual. In further embodiments, the executable instructions are configured to cause the display of identified context-specific words and phrases in a scrollable, selectable format on a display screen. In certain embodiments, the executable instructions are configured to employ identified context-specific terms as search terms in a database and to display the results of such search terms as additional selectable words and phrases. In selected embodiments, the computer readable medium includes computer readable and executable instructions configured to apply facial recognition and voice identification algorithms to previously recorded and/or real time data to identify individuals.

In a still further example, another embodiment of the disclosed technology concerns an electronic device, such as but not limited to a speech generation device, including such hardware components as at least one electronic input device, at least one electronic output device, at least one processing device and at least one memory. The at least one electronic output device can be configured to display a plurality of graphical user interface design areas to a user, wherein a plurality of display elements are placed within the graphical user interface design areas. The at least one electronic input device can be configured to receive electronic input from a user corresponding to data for selecting one or more of a number of display element types to be placed within the graphical user interface area. The at least one memory may comprise computer-readable instructions for execution by said at least one processing device, wherein said at least one processing device is configured to receive the electronic input defining the various features of the graphical user interface and to initiate a graphical user interface having such features.

In more particular exemplary embodiments of an electronic device, the electronic device may comprise a speech generation device that comprises at least one input device (e.g., touchscreen, eye tracker, mouse, keyboard, joystick, switch or the like) by which an AAC device user may specify a context manually. In certain embodiments, the electronic device may be provided with a camera or other visual input means and/or a microphone or other audio input means to provide analysis for facial and speech recognition. In other instances, the electronic device may be provided with a bar code scanner to read 2D matrix or other barcodes within a user's environment to assist with determining a communication context. In still further embodiments, an electronic device may be provided with at least one speaker for providing audio output. In such embodiments, the at least one processing device can be further configured to associate selected ones of the plurality of display elements with one or more given electronic actions relative to the communication of speech-generated message output provided by the electronic device.

Additional aspects and advantages of the disclosed technology will be set forth in part in the description that follows, and in part will be obvious from the description, or may be learned by practice of the technology. The various aspects and advantages of the present technology may be realized and attained by means of the instrumentalities and combinations particularly pointed out in the present application.

### BRIEF DESCRIPTION OF THE DRAWINGS

The accompanying drawings, which are incorporated in and constitute a part of this specification, illustrate one or more embodiments of the presently disclosed subject matter. These drawings, together with the description, serve to explain the principles of the disclosed technology but by no means are intended to be exhaustive of all of the possible manifestations of the present technology.

FIG. 1A provides a schematic diagram of exemplary software modules for use in a computerized method of providing electronic features for creating context-aware language suggestions for an electronic device;

FIG. 1B provides a flow chart of exemplary steps in a method of providing electronic features for creating context-aware language suggestions for an electronic device;

FIG. 2 depicts a first exemplary embodiment of a graphical user interface area with a plurality of display elements in accordance with aspects of the presently disclosed technology;

FIG. 3 depicts a second exemplary embodiment of a graphical user interface area with a plurality of display elements in accordance with aspects of the presently disclosed technology;

FIG. 4 depicts a third exemplary embodiment of a graphical user interface area with a plurality of display elements in accordance with aspects of the presently disclosed technology; and,

FIG. 5 provides a schematic view of exemplary hardware components for use in an exemplary speech generation device for providing context aware vocabulary suggestion features in accordance with aspects of the presently disclosed technology.

### DETAILED DESCRIPTION OF THE PREFERRED EMBODIMENTS

Reference now will be made in detail to the presently preferred embodiments of the disclosed technology, one or more examples of which are illustrated in the accompanying drawings. Each example is provided by way of explanation of the technology, which is not restricted to the specifics of the examples. In fact, it will be apparent to those skilled in the art that various modifications and variations can be made in the present subject matter without departing from the scope or spirit thereof. For instance, features illustrated or described as part of one embodiment, can be used on another embodiment to yield a still further embodiment. Thus, it is intended that the presently disclosed technology cover such modifications and variations as may be practiced by one of ordinary skill in the art after evaluating the present disclosure. The same numerals are assigned to the same or similar components throughout the drawings and description.

Referring now to the drawings, various aspects of a system and method of providing electronic features for creating context-aware message item suggestions for inclusion in composing messages for an electronic device are disclosed. In general, the subject technology provides features by which a user can be provided with a context-aware library of communicator-specific and/or location-specific message items such as words, phrases, symbols, vocabulary or other language elements for inclusion in composing messages. Such feature allows the user to quickly interact with identified individuals and comment on people, facts or information related to the identified individuals and/or to a present or previously visited location or other related location or location related places, events, or other information.

The ability to provide customized word and phrase selection libraries for an electronic device provides a variety of advantages. For example, interfaces can be created that provide enhanced response rates for alternative and augmentative communications (AAC) device users wishing, for example, to engage in a discussion of a location being visited for the first time which includes words and phrases that are generally new or foreign to the vocabulary normally used or currently available to the user. By providing a context-aware vocabulary from which the user may select words or phrases specific to her location the user will be able to more readily compose messages relating to the material. Context-aware libraries will also reduce the cognitive load for the user and improve the overall learning experience.

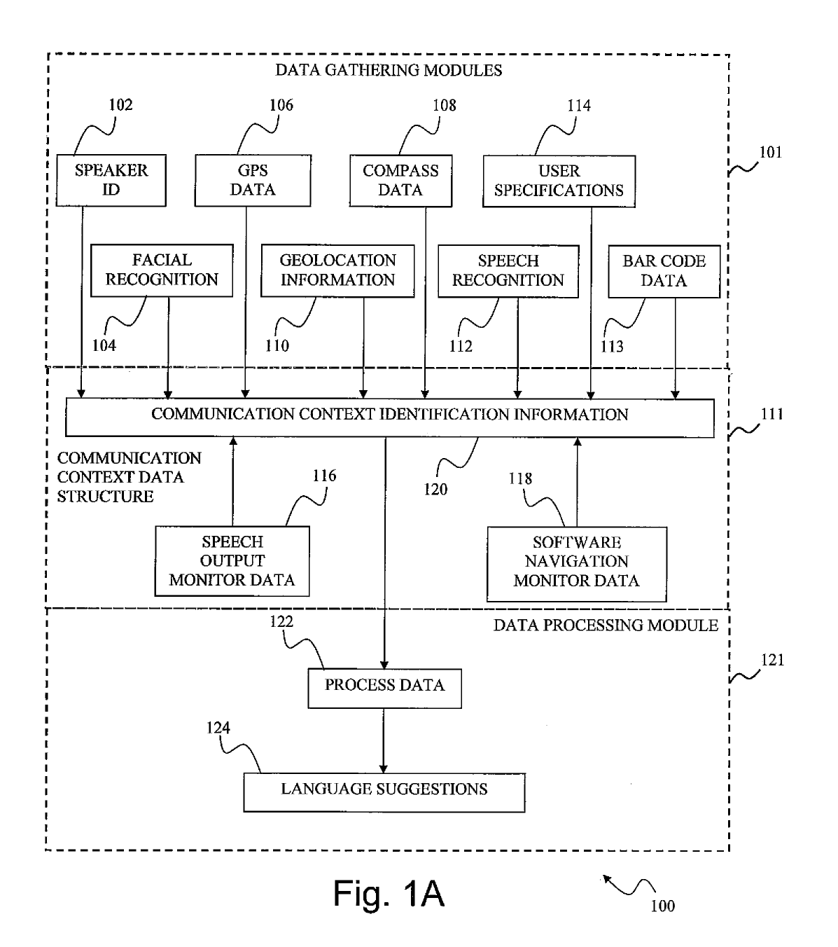

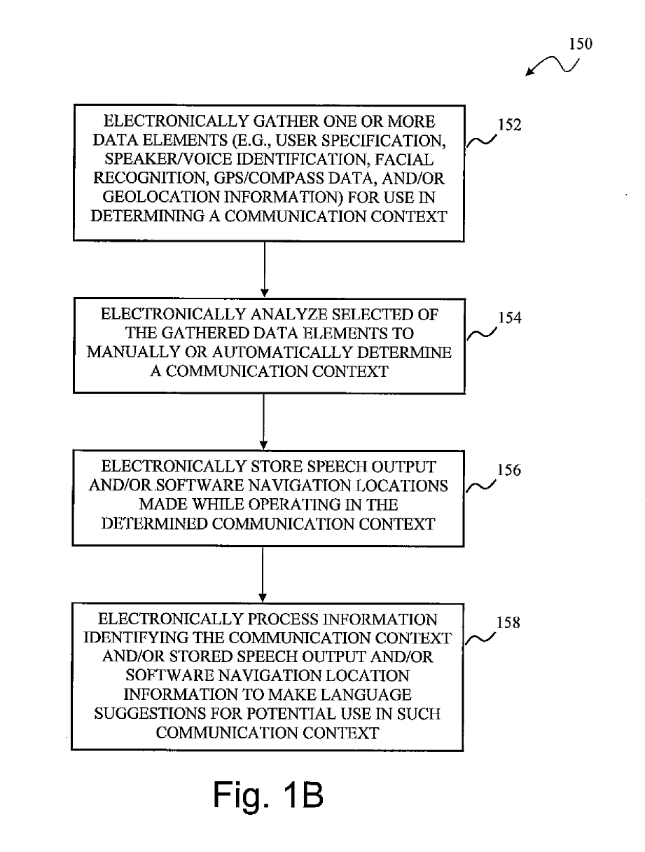

FIGS. 1A and 1B provide schematic diagrams related to a method of providing electronic features for creating an automated customized context-aware message item choices interface for an electronic device in accordance with present technology. FIG. 1B provides a flow chart 150 of exemplary steps in such a method, while FIG. 1A provides a schematic overview 100 of exemplary software modules that can combine to implement selected of the steps such as those shown in FIG. 1B and those otherwise disclosed in the present application. In general, the software modules of FIG. 1A are categorized in one of three general areas—data gathering modules 101, a communication context data structure 111 and a data processing module 121. Various embodiments of the presently disclosed technology may include some or all of the modules provided in FIG. 1A. Similarly, the steps provided in FIG. 1B may be performed in the order shown in such figure or may be modified in part, for example to exclude optional steps or to perform steps in a different order than shown in FIG. 1B.

The modules shown in FIG. 1A and the steps shown in FIG. 1B illustrate various aspects of an electronically-implemented computer-based process. Computerized processing of electronic data in a manner as set forth in FIG. 1B may be performed by a special-purpose machine corresponding to some computer processing device configured to implement such electronically implemented process. For example, a hardware embodiment is shown in FIG. 5 which may be used to implement the subject process, particularly where the modules shown in FIG. 1A are stored in one or more of the memory/media devices shown in FIG. 5.

Referring now to FIG. 1B, a first exemplary step 152 in accordance with the present automated method corresponds to electronically gathering one or more data elements for use in determining a communication context. Exemplary data elements may correspond to such items as user specification, speaker/voice identification, facial recognition, speech content, GPS/compass data and/or geolocation information. One or more software modules 101 as shown in FIG. 1A may be configured for accomplishing the data gathering step 152. Exemplary data gathering software modules may include, without limitation, a speaker identification (i.e., voice recognition) module 102, facial recognition module 104, GPS data module 106, compass data module 108, geolocation information module 110, speech recognition (i.e., speech content determination) module 112, bar code data module 113 and user specifications module 114. Each of these information gathering modules will be described more fully below.

One or more of the data gathering modules 101 generally may be used for communicator identification, including but not limited to the speaker identification module 102 and/or the facial recognition module 104 and/or the speech recognition module 112. It should be appreciated that the data gathering modules described above may be useful for identifying communicators including not only the user of an AAC device, but additionally or alternatively one or more communication partners with whom a user is communicating. For example, speaker voice recognition, speech recognition and/or facial recognition can be variously used to identify just the user, just the communication partner(s), or both parties to a conversation. This versatility can help provide a broader range of customization in accordance with the disclosed context-specific communications options by creating a communication context that is dependent on one or more of a variety of individuals whom are party to an electronically tracked conversation using an AAC device.

With more particular reference to the data gathering modules 101 that may be used for communicator identification, speaker identification module 102 can be used to identify a user and/or communication partner via voice recognition techniques. Such module 102 may correspond to an audio speaker identification program via voice recognition software analysis of audio received by, for example, microphone 508 (FIG. 5). Speaker identification via voice recognition can be implemented, for example, by comparing gathered voice samples to a prerecorded library of known samples. Identification of a user and/or communication partner may also be made via facial recognition module 104 in conjunction with facial recognition software and an input from, for example, camera 519 (FIG. 5). Still further, analysis of the words, phrases, etc. contained in a speech sample can be used to determine speech content which may also be used to identify a user and/or communicator. For example, speech recognition module 112 can use speech-to-text conversion software to convert a user's speech into resultant text to identify the speaker based on the speaker's conversation content. In an exemplary, non-limiting, implementation, Dragon Naturally Speaking™ software by Nuance Communications, Inc. may be employed to provide speech-to-text conversion to provide text usable in a search engine to identify the speaker. Similar text-to-speech conversion software may be used in the speech output monitor data module 116, which is described later in more detail.

In any instance of communicator identification, further processing of an obtained identification of a user and/or communication partner such as by search of online or local databases will provide the user with relevant communicator-specific message item choices as an aid to message composition. Local databases could be stored, for example, in one of memory devices 504a, 504b, and/or 504c (FIG. 5), and online databases may correspond to those provided by an online search engine, for example without limitation, Google, Bing™, Snap™, Yahool®, and Lycos®, that may be accessed via the Internet using onboard Network Communication Interface 520 (FIG. 5) of AAC device 500.

To appreciate the types of communicator-specific language elements or related message items (e.g., pictures, symbols, phrases and the like) that may be developed in accordance with the disclosed technology, consider the identification of a communication partner as a particular friend or acquaintance of the AAC device user. A search of a previously generated local database may result in presenting the user with a communicator-specific message item list including such as the identified communicator's spouse's name, children's names, pet's name, home town, job title, hobbies or other related information. Symbols and/or phrases or other language elements or message items related to these communicator-specific vocabulary choices may also be provided.

Referring still to FIG. 1A, some other data gathering modules 101 may generally include software features for identifying location information, and include such examples as a GPS data module 106, compass data module 108, and geolocation information module 110. Such modules may be used individually and/or collectively to provide information regarding a user's current or previously visited locations. Location information can also be obtained by triangulation methods using cellular telephone tower locations using cellular phone device 510 (FIG. 5). In one example, if a GPS receiver associated with an AAC device provided location information of 35° 32′ 25.56″ N 82° 38′ 06.46″ W and a compass, for example, a fluxgate magnetometer compass, also associated with the AAC device indicated you were facing in a west north west (WNW) direction, a search of, for example, Google Earth®, Google Maps®, or MapQuest® online, or a mapping database local to the AAC device, would reveal that you are standing in the front lawn of the Biltmore House in Asheville, N.C. and you are looking at the house.

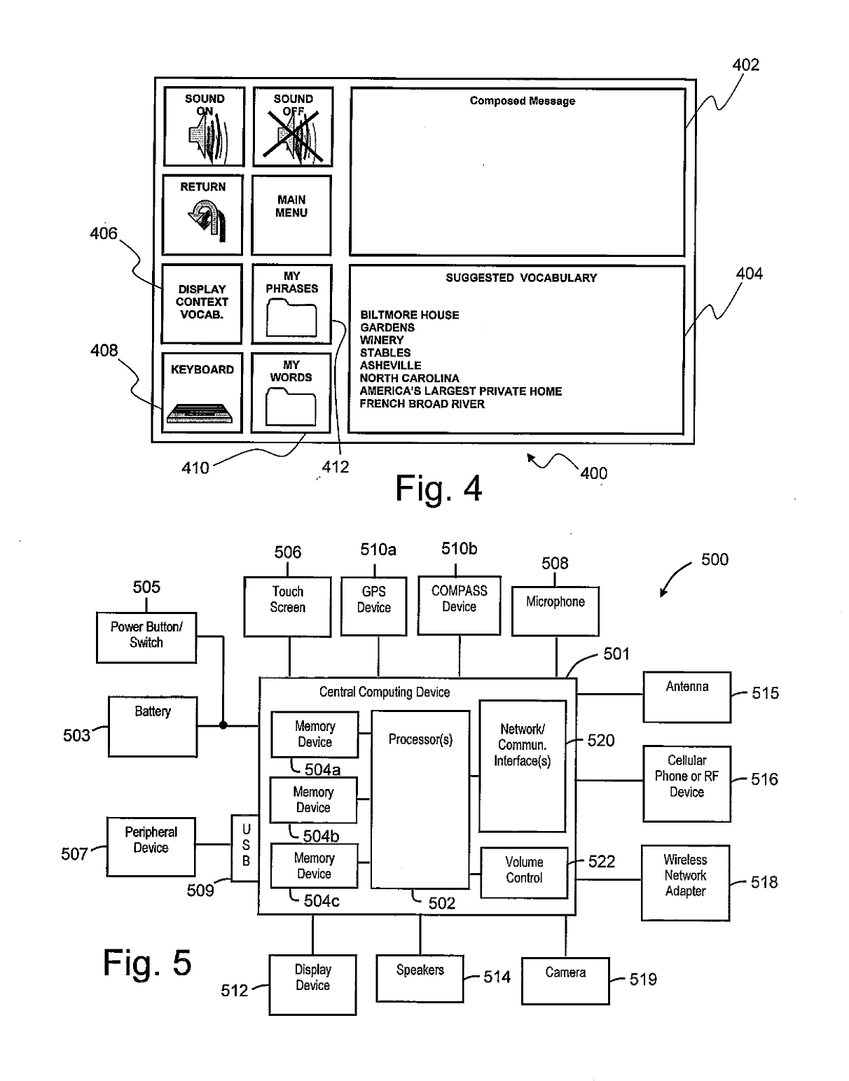

The location information gathered via one or more of the GPS data module 106, compass data module 108, and geolocation information module 110 may be ultimately processed similar to the communicator identification information such as by search of online or local databases to provide the user with relevant location-specific message item choices as an aid to message composition. For example, a search for the Biltmore House would reveal geolocation information 110 including, for example, the name of the river passing along the property (French Broad River), and the fact that there are a winery, stables, and gardens associated with the property. Such a search may also reveal that the Biltmore House is America's largest private home. As will be described later with respect to FIG. 4, in accordance with the present technology, each of these items may be displayed as location-specific vocabulary suggestions to an AAC device user to assist the user in carrying on a conversation. Corresponding pictures, symbols, phrases and/or other message items may also be developed for presentation to a user.

A still further data gathering module 101 in accordance with the presently disclosed technology more particularly concerns a bar code data module 113. Bar code data module 113 may correspond to the software interfacing features and resultant data provided when an AAC device includes an integrated bar code reader or when a bar code reader is attached as a peripheral device to an AAC device (e.g., using a bar code reader/scanner as peripheral device 507 in FIG. 5). Bar codes readable by such a bar code reader/scanner may be placed within a user's environment and be associated with one or more identifying items, including but not limited to people, things, places, events and the like. Each bar code may then either store additional information associated with its identifying item or may contain information about an electronic link (e.g., website URL, RF transmission connection information, etc.) to such additional information. Bar code input information may particularly correspond to information used for communicator identification and/or location identification aspects associated with identifying a communication context.

For example, each friend or family member of an AAC device user may have a bar code associated therewith such that the AAC device user can scan a communicator's associated barcode when the AAC device user is interacting with such communicator. This provides the AAC device user (and the user's AAC device) with an affirmative identification of the communicator, and in some cases an identification that is even more reliable than other identification means such as voice recognition, speech recognition, and the like. Understanding that bar codes may not be available for every person or place, one of ordinary skill in the art will appreciate that multiple identification modules in addition to barcode input modules may also be employed in an AAC device of the presently disclosed technology. In addition to identifying the communicator, each bar code read by a bar code reader/scanner associated with an AAC device may thus provide a variety of information associated with that individual. For example, a bar code may provide not only the name of an individual communicator, but also information such as that person's birthday, the names of his family members, his hobbies, address, and the like. The AAC device user thus has ready access to important information about such person, and can then use that information in communicating with that person. This information may be encoded directly within the optical parameters of a barcode. Or alternatively, each barcode provides information to a communication link (e.g., an item-specific URL) where information about a communicator or other item can be stored and continually updated.

The types of bar codes and encoding used in accordance with bar code data module 113 and any associated reader/scanner hardware may be in accordance with a variety of known standards or standards as developed in the future that provide a suitable optical machine-readable representation of data that is specific to each coded item. Two-dimensional (2D) or matrix barcode technology may be particularly applicable for use with the disclosed technology since such bar codes generally have a higher data representation capability than one-dimensional (1D) barcodes, although 1D barcodes are not excluded. Non-limiting examples of matrix/2D barcodes for use with the disclosed technology include QR codes, stacked barcodes, multi-segment barcodes, high capacity color barcodes and the like.

Further with respect to step 152 of FIG. 1B, additional information that may be gathered for use in subsequently determining a communication context may include a user specifications module 114. In some instances, the user specifications module 114 may include data corresponding to a user's manual specification of a particular context within which the user wants to operate. For example, a user's AAC device may be adapted with several different preconfigured communication contexts based on different people with whom the user interacts (e.g., spouse, caregiver, friends, etc.) or different places (e.g., home, work, school, etc.). An AAC device can be provided with selectable software features for the user to manually select a communications context for these given operational environments. The user specifications module 114 can then receive such user-selected context information and utilize it to automatically toggle a preconfigured communication context as opposed to automatically determining the best context based on other analyzed information (e.g., communicator identification information and/or location information.)

With further respect to user specifications module 114, the user specifications module may track the operational features of an AAC device selected by a user. It should be appreciated that an AAC device user may select certain operational features, and the way those features are configured may indicate something about the user. For example, a user may choose to operate his AAC device such that messages are composed with text only, with symbols only, or with a combination of text and symbols. In another example, a user may choose to operate his AAC device with one of many different input options, such as but not limited to the “Touch Enter,” “Touch Exit,” “Touch Auto Zoom,” “Scanning,” “Joystick,” “Auditory Touch,” “Mouse Pause/Headtrackers,” “Morse Code,” and/or “Eye Tracking” access modes. In a still further example, the previously mentioned camera input may be altered to permit selection of an external camera by way of a peripheral device 507 (FIG. 5) USB connection to the AAC device. Other selection options may include selecting the use of GPS vs. triangulation via cellular towers to obtain location information. The context determination features of the presently disclosed technology may track the above exemplary operational features of an AAC device and other operational features to help analyze and determine the most appropriate communications context for a user.

Regardless of the sources of information, including the ones mentioned above as well as other sources as may become apparent to those of ordinary skill in the art from a reading of the present disclosure, these information sources all provide data to a communication context data structure 111 as shown in FIG. 1A. It is within the confines of the communication context data structure 111 that selected gathered data elements are analyzed per step 154 of FIG. 1B to manually or automatically determine a communication context. The determined communication context may then be stored as a separate data variable represented by the communication context identification information 120 within communication context data structure 111. In general, communication context identification information 111 provides a profile of a user and/or one or more of the user's communication partners and/or one or more of the locations, speech, device specifications or other related aspects associated with device use. The specifics of the profile are then used to develop communicator-specific and/or location-specific message items for display to a user for selectable inclusion in messages being composed by the user on an AAC device.

Referring still to FIGS. 1A and 1B, it should be appreciated that additional information may be gathered once a communication context has been determined. More particularly, step 156 of FIG. 1B indicates that speech output and/or software navigation locations made while operating in a given communication context (as determined in step 154) may also be electronically stored. Such data is indicated in FIG. 1A as the modules for monitoring the speech output 116 of the AAC device as well as the software navigation data 118, i.e., navigation steps a user has followed during the operation of the AAC device. Both of these features may be used to provide input that may be used to further expand vocabulary suggestions offered to the AAC device user. For example, if the user has caused the AAC device to ask a question of her conversation partner about the winery associated with the Biltmore estate, vocabulary suggestions listing different types of wine or wine related terms may be included in a vocabulary suggestions list. In like manner, if a user has used the AAC device software to specify cellular tower location determination as opposed to more accurate GPS location, vocabulary suggestions may be expanded to cover more distant locations, for example, downtown Asheville, as opposed to the more precise location of the lawn in front of the Biltmore House.

It should be appreciated that additional information may also be collected that is pertinent to the context in which an AAC device user may find himself that may also be used in conjunction with the present technology. For example, the network communication interface 520 (FIG. 5) may be operated in conjunction with either the GPS data 106 or triangulation information based on cellular tower locations to obtain a local weather report so that relevant context-aware vocabulary suggestions regarding, for example, an approaching thunderstorm may also be presented to the AAC device user.

Referring again to FIGS. 1A and 1B, once a communication context has been identified in module 120, and any additional information has been gathered in modules 116 and 118, some or all of such data is provided to data processing module 121. In data processing module 121 of FIG. 1A, step 158 of FIG. 1B is implemented. Step 158 involves electronically processing information identifying the communication context and/or stored speech output and/or stored navigation location information to make language or other message item suggestions for potential use in the determined communication context. Software instructions and rules for processing data may be stored in the process data module 122 of FIG. 1A and the generated language suggestions may be stored in module 124. As previously described, the processing step 158 may involve conducting a local or online search relating to identified items defining a communication context (e.g., determined location, determined communicator name, etc.)

In some embodiments, local and/or online databases may be configured with predetermined or adaptable links among associated vocabulary elements to readily assist with the suggestion of communicator-specific message and/or location-specific message items. When links are adaptable, a user can link words for future presentation when in a given communication context is determined. When speech output and/or location information is recorded in conjunction with a communication context, vocabulary identified from the speech and/or location can be linked to the communication context. For example, if location information helps identify as part of the determined communication context that the user is in Asheville, N.C., then linked location-specific vocabulary elements might include Asheville, North Carolina, Blue Ridge Parkway, Biltmore House, French Broad River and the like. Having these location-specific message items readily at hand can facilitate a user's communication regarding his determined location. In another example, if a communicator is determined to be a user's acquaintance Tommy and speech output while within that communication context frequently references a dog named Spike and certain items related to the game of golf, then keywords from such speech (e.g., “dog,” “Spike,” “golf”) with optional symbols or pictures may be presented as suggested message items to a user. In this fashion, while in a given communication context, some or all speech output and software navigation locations can be recorded and used to determine suggested language when next in the same communication context.

Once particular message items (e.g., words, phrases, symbols, pictures, and other language items) are identified for suggestion to a user, such message items may be provided as output to a user. More particularly, such items may be displayed on a screen associated with the AAC device, preferably in an array of selectable items. In one example, a scrollable, selectable format can be used on a display screen for suggested message items. Additional aspects of how exemplary language suggestions 124 may be presented to an ACC device user will be explained more fully later with respect to FIG. 4.

It should be appreciated at this point that while the present exemplary embodiments are described in terms of a present context, the present technology may be equally well applied to past contexts that may be contained within the communication context data structure 120 and may, for example, become part of a searched database from which vocabulary suggestions may be offered to an AAC device user. For example, the AAC device user may have previously visited some other famous home so that vocabulary suggestions relative to that previous visit may be presented, possibly based on optional settings selected by user specifications 114.

The present technology also may be equally applied in other context-aware situations such as file or document management. For example, static or interactive files or documents may include elements susceptible of association with a present or past context. Exemplary elements may include, but are not limited to, graphic, audio, video, multi-media, word processing, database, or other files, documents, or elements within such items. Such provision is well within the scope of the present technology and is well suited to situations where an AAC device user would wish to discuss a related visit or a planned future visit to a new location.

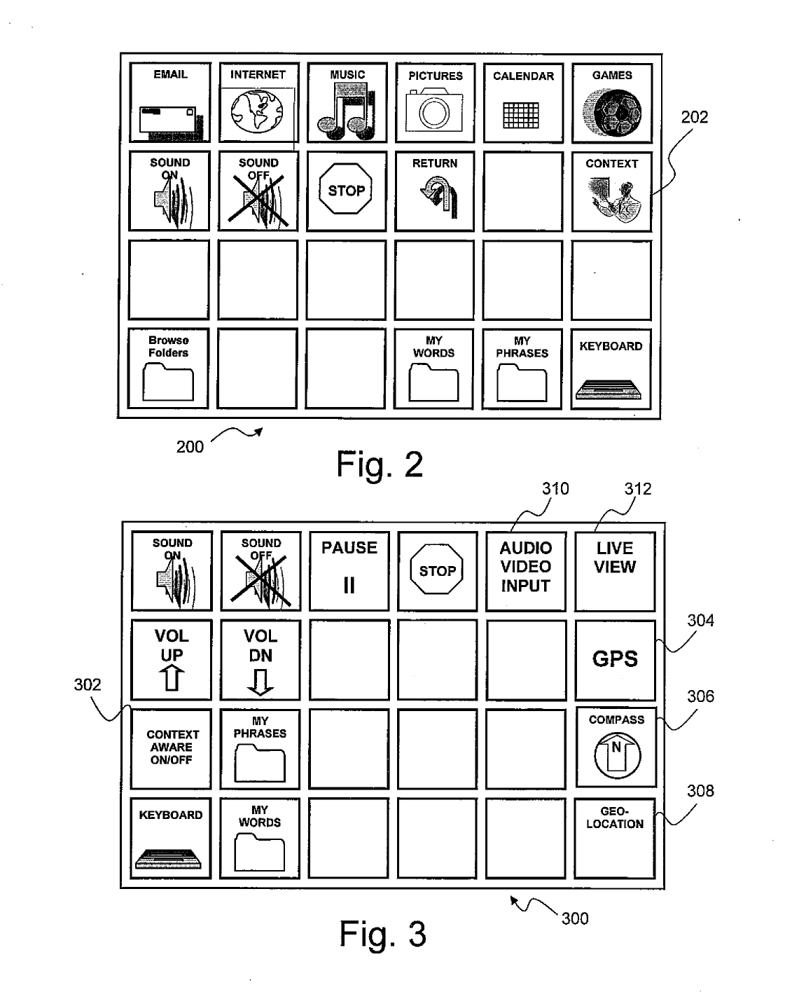

With reference now to FIG. 2, there is illustrated a first exemplary embodiment of a graphical user interface area 200 with a plurality of display elements in accordance with aspects of the presently disclosed technology. As may be seen, graphical user interface area 200 may correspond to an initial interface area as presented upon power up of an AAC device constructed in accordance with present technology. Upon power up, graphical user interface area 200 provides a number of selection item buttons including EMAIL, INTERNET, MUSIC, PICTURES, CALENDAR, GAMES, etc., and, in accordance with the present subject matter, a CONTEXT selection button 202. Upon touching the CONTEXT selection button 202, graphical user interface area 200 is changed to display a CONTEXT graphical user interface area 300.

With reference to FIG. 3, there is illustrated a second exemplary embodiment of a graphical user interface area 300 with a plurality of display elements in accordance with aspects of the presently disclosed technology. More particularly, graphical user interface area 300 provides an enlarged screen area 302 on which may be viewed a live or recorded presentation from which vocabulary may be extracted in accordance with present technology. Exemplary operational selection buttons are provided to, for example, select from buttons for a GPS 304, COMPASS 306, GEOLOCATION 308, AUDIO VIDEO INPUT 310, LIVE VIEW 312, and to activate or disable the context-aware vocabulary process via CONTEXT AWARE ON/OFF 302. As is evident from an inspection of FIG. 3, a number of other exemplary options are also available and provide other relevant operational options. Those of ordinary skill in the art will appreciate that other or additional options may also be provided.

Selection of button 310 for and AUDIO VIDEO INPUT will enable inputs from a peripheral device, e.g., peripheral device 507 illustrated in FIG. 5, as will be further discussed later. Alternatively, selection of button 312 for LIVE VIEW, may activate camera 519 and/or microphone 508, also shown in FIG. 5.

Upon selection of button 302 to activate the context-aware process, a third exemplary embodiment of a graphical user interface area 400 with a plurality of display elements in accordance with aspects of the presently disclosed technology will be presented to the AAC device user.

Upon selection of DISPLAY CONTEXT VOCAB button 406, a number of words, phrases, symbols and/or other message items may appear on SUGGESTED VOCABULARY area 404 corresponding to suggestions based on data contained in communication context data structure 111 (FIG. 1A). Generally these words and phrases will correspond to words and phrases not normally included in an AAC device user's MY WORDS 410 or MY PHRASES 412 selection areas or in some other static vocabulary source initialized by the AAC device. Although not presently illustrated in FIG. 4, the words or phrases displayed in the SUGGESTED VOCABULARY area 404 may additionally or alternatively be shown with associated symbols. By providing the suggested words and phrases, an AAC device user's communication capabilities are significantly enhanced when communicating with other individuals regarding the experienced presentation.

It is noted that the AAC device user does retain the option of selecting a KEYBOARD input 408 through which she may type any desired word or phrase. It should be appreciated that upon selection of any of the buttons 406, 408, 410, 412, a corresponding area 404 will be presented. In this manner, for example, a scrollable, selectable group of words and phrases as illustrated in area 404 will be presented corresponding to the selected input button 406, 408, 410, 412. In the case of a KEYBOARD button 408, a QWERTY type keyboard may be displayed in area 404 to assist in typing words not present in any of the other selectable areas.

Referring now to FIG. 5, additional details regarding possible hardware components that may be provided to implement the various graphical user interface and media player creation features disclosed herein are provided. FIG. 5 depicts an exemplary electronic device 500, which may correspond to any general electronic device including such components as a computing device 501, at least one input device (e.g., one or more of touch screen 506, microphone 508, GPS device 510a, compass device 510b, camera 519 or the like) and one or more output devices (e.g., display device 512, speaker 514, a communication module or the like).

In more specific examples, electronic device 500 may correspond to a stand-alone computer terminal such as a desktop computer, a laptop computer, a netbook computer, a palmtop computer, a speech generation device (SGD) or alternative and augmentative communication (AAC) device, such as but not limited to a device such as offered for sale by DynaVox Mayer-Johnson of Pittsburgh, Pa. including but not limited to the V™ device, Vmax™ device, Xpress™ device, Tango™ device, M³™ device and/or DynaWrite™ products, a mobile computing device, a handheld computer, a tablet computer (e.g., Apple's iPad tablet), a mobile phone, a cellular phone, a VoIP phone, a smart phone, a personal digital assistant (PDA), a BLACKBERRY™ device, a DROID™, a TREO™, an iPhone™, an iPod Touch™, a media player, a navigation device, an e-mail device, a game console or other portable electronic device, a combination of any two or more of the above or other electronic devices, or any other suitable component adapted with the features and functionality disclosed herein.

When electronic device 500 corresponds to a speech generation device, the electronic components of device 500 enable the device to transmit and receive messages to assist a user in communicating with others. For example, electronic device 500 may correspond to a particular special-purpose electronic device that permits a user to communicate with others by producing digitized or synthesized speech based on configured messages. Such messages may be preconfigured and/or selected and/or composed by a user within a message window provided as part of the speech generation device user interface. As will be described in more detail below, a variety of physical input devices and software interface features may be provided to facilitate the capture of user input to define what information should be displayed in a message window and ultimately communicated to others as spoken output, text message, phone call, e-mail or other outgoing communication.

Referring more particularly to the exemplary hardware shown in FIG. 5, a computing device 501 is provided to function as the central controller within the electronic device 500 and may generally include such components as at least one memory/media element or database for storing data and software instructions as well as at least one processor. In the particular example of FIG. 5, one or more processor(s) 502 and associated memory/media devices 504a, 504b and 504c are configured to perform a variety of computer-implemented functions (i.e., software-based data services). The one or more processor(s) 502 within computing device 501 may be configured for operation with any predetermined operating systems, such as but not limited to Windows XP, and thus is an open system that is capable of running any application that can be run on Windows XP. Other possible operating systems include Android OS, WebOS, BSD UNIX, Darwin (Mac OS X including “Cheetah,” “Leopard,” “Snow Leopard” and other variations), Linux, SunOS (Solaris/OpenSolaris), and Windows NT (XPNista/7).

At least one memory/media device (e.g., device 504a in FIG. 5) is dedicated to storing software and/or firmware in the form of computer-readable and executable instructions that will be implemented by the one or more processor(s) 502. Other memory/media devices (e.g., memory/media devices 504b and/or 504c) are used to store data which will also be accessible by the processor(s) 502 and which will be acted on per the software instructions stored in memory/media device 504a. Computing/processing device(s) 502 may be adapted to operate as a special-purpose machine by executing the software instructions rendered in a computer-readable form stored in memory/media element 504a. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific integrated circuits.

The various memory/media devices of FIG. 5 may be provided as a single portion or multiple portions of one or more varieties of computer-readable media, such as but not limited to any combination of volatile memory (e.g., random access memory (RAM, such as DRAM, SRAM, etc.)) and nonvolatile memory (e.g., ROM, flash, hard drives, magnetic tapes, CD-ROM, DVD-ROM, etc.) or any other memory devices including diskettes, drives, other magnetic-based storage media, optical storage media and others. In some embodiments, at least one memory device corresponds to an electromechanical hard drive and/or or a solid state drive (e.g., a flash drive) that easily withstands shocks, for example that may occur if the electronic device 500 is dropped. Although FIG. 5 shows three separate memory/media devices 504a, 504b and 504c, the content dedicated to such devices may actually be stored in one memory/media device or in multiple devices. Any such possible variations and other variations of data storage will be appreciated by one of ordinary skill in the art.

In one particular embodiment of the present subject matter, memory/media device 504b is configured to store input data received from a user, such as but not limited to audio/video/multimedia files for analysis and vocabulary extraction in accordance with the presently disclosed technology. Such input data may be received from one or more integrated or peripheral input devices 510a, 510b associated with electronic device 500, including but not limited to a keyboard, joystick, switch, touch screen, microphone, eye tracker, camera, or other device. Memory device 504a includes computer-executable software instructions that can be read and executed by processor(s) 502 to act on the data stored in memory/media device 504b to create new output data (e.g., audio signals, display signals, RF communication signals and the like) for temporary or permanent storage in memory, e.g., in memory/media device 504c. Such output data may be communicated to integrated and/or peripheral output devices, such as a monitor or other display device, or as control signals to still further components.

Referring still to FIG. 5, central computing device 501 also may include a variety of internal and/or peripheral components in addition to those already mentioned or described above. Power to such devices may be provided from a battery 503, such as but not limited to a lithium polymer battery or other rechargeable energy source. A power switch or button 505 may be provided as an interface to toggle the power connection between the battery 503 and the other hardware components. In addition to the specific devices discussed herein, it should be appreciated that any peripheral hardware device 507 may be provided and interfaced to the speech generation device via a USB port 509 or other communicative coupling. It should be further appreciated that the components shown in FIG. 5 may be provided in different configurations and may be provided with different arrangements of direct and/or indirect physical and communicative links to perform the desired functionality of such components.

Various input devices may be part of electronic device 500 and thus coupled to the computing device 501. For example, a touch screen 506 may be provided to capture user inputs directed to a display location by a user hand or stylus. A microphone 508, for example a surface mount CMOS/MEMS silicon-based microphone or others, may be provided to capture user audio inputs. Other exemplary input devices (e.g., peripheral device 510) may include but are not limited to a peripheral keyboard, peripheral touch-screen monitor, peripheral microphone, mouse and the like. A camera 519, such as but not limited to an optical sensor, e.g., a charged coupled device (CCD) or a complementary metal-oxide semiconductor (CMOS) optical sensor, or other device can be utilized to facilitate camera functions, such as recording photographs and video clips, and as such may function as another input device. Hardware components of SGD 500 also may include one or more integrated output devices, such as but not limited to display 512 and/or speakers 514.

Display device 512 may correspond to one or more substrates outfitted for providing images to a user. Display device 512 may employ one or more of liquid crystal display (LCD) technology, light emitting polymer display (LPD) technology, light emitting diode (LED), organic light emitting diode (OLED) and/or transparent organic light emitting diode (TOLED) or some other display technology. In one exemplary embodiment, a display device 512 and touch screen 506 are integrated together as a touch-sensitive display that implements one or more of the above-referenced display technologies (e.g., LCD, LPD, LED, OLED, TOLED, etc.) or others.

Speakers 514 may generally correspond to any compact high power audio output device. Speakers 514 may function as an audible interface for the speech generation device when computer processor(s) 502 utilize text-to-speech functionality. Speakers can be used to speak the messages composed in a message window as described herein as well as to provide audio output for telephone calls, speaking e-mails, reading e-books, and other functions. Speech output may be generated in accordance with one or more preconfigured text-to-speech generation tools in male or female and adult or child voices, such as but not limited to such products as offered for sale by Cepstral, HQ Voices offered by Acapela, Flexvoice offered by Mindmaker, DECtalk offered by Fonix, Loquendo products, VoiceText offered by NeoSpeech, products by AT&T's Natural Voices offered by Wizzard, Microsoft Voices, digitized voice (digitally recorded voice clips) or others. A volume control module 522 may be controlled by one or more scrolling switches or touch-screen buttons.

The various input, output and/or peripheral devices incorporated with SGD 500 may work together to provide one or more access modes or methods of interfacing with the SGD. In a “Touch Enter” access method, selection is made upon contact with the touch screen, with highlight and bold options to visually indicate selection. In a “Touch Exit” method, selection is made upon release as a user moves from selection to selection by dragging a finger as a stylus across the screen. In a “Touch Auto Zoom” method, a portion of the screen that was selected is automatically enlarged for better visual recognition by a user. In a “Scanning” mode, highlighting is used in a specific pattern so that individuals can use a switch (or other device) to make a selection when the desired object is highlighted. Selection can be made with a variety of customization options such as a 1-switch autoscan, 2-switch directed scan, 2-switch directed scan, 1-switch directed scan with dwell, inverse scanning, and auditory scanning. In a “Joystick” mode, selection is made with a button on the joystick, which is used as a pointer and moved around the touch screen. Users can receive audio feedback while navigating with the joystick. In an “Auditory Touch” mode, the speed of directed selection is combined with auditory cues used in the “Scanning” mode. In the “Mouse Pause/Headtrackers” mode, selection is made by pausing on an object for a specified amount of time with a computer mouse or track ball that moves the cursor on the touch screen. An external switch exists for individuals who have the physical ability to direct a cursor with a mouse, but cannot press down on the mouse button to make selections. A “Morse Code” option is used to support one or two switches with visual and audio feedback. In “Eye Tracking” modes, selections are made simply by gazing at the device screen when outfitted with eye controller features and implementing selection based on dwell time, eye blinking or external switch activation.

Referring still to FIG. 5, SGD hardware components also may include various communication devices and/or modules, such as but not limited to an antenna 515, cellular phone or RF device 516 and wireless network adapter 518. For example, antenna 515 may be provided to facilitate wireless communications among the components of SGD 500 and/or between SGD 500 and other devices (e.g., a secondary computer) in accordance with one or more of a variety of RF communication protocols including, but not limited to Bluetooth®, WiFi (802.11 b/g/n), and ZigBee® wireless communication protocols. A cellular phone or other RF device 516 may be provided to enable the user to make phone calls directly and speak during the phone conversation using the SGD, thereby eliminating the need for a separate telephone device. A wireless network adapter 518 may be provided to enable access to a network, such as but not limited to a dial-in network, a local area network (LAN), wide area network (WAN), public switched telephone network (PSTN), the Internet, intranet or ethernet type networks or others. Additional communication modules such as but not limited to an infrared (IR) transceiver may be provided to function as a universal remote control for the SGD that can operate devices in the user's environment, for example including TV, DVD player, and CD player. When different wireless communication devices are included within an SGD, a dedicated communications interface module 520 may be provided within central computing device 501 to provide a software interface from the processing components of computer 501 to the communication device(s).

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of creating context-aware message item suggestions for inclusion in composing messages for an electronic device, said method comprising:
electronically gathering one or more data elements characterizing one or more of a communicator and location associated with an electronic device;
electronically analyzing selected ones of the one or more data elements to determine a communication context, wherein said communication context comprises a data structure that provides a profile defined by the analyzed data elements;
electronically processing information identifying the communication context to make message item suggestions for potential use while the electronic device is operating in the determined communication context; and
electronically providing to a user the message item suggestions as an array of selectable output items on a display component of the electronic device.

2. The method of claim 1, wherein the message item suggestions comprise one or more of vocabulary, words, phrases and symbols.

3. The method of claim 1, wherein said electronic device comprises a speech generation device.

4. The method of claim 1, wherein said data elements comprise one or more communicator-specific data elements defining a user or communication partner of the electronic device, said communicator-specific data elements comprising one or more of user specification data, speech content data, voice identification data and facial recognition data.

5. The method of claim 1, wherein said data elements comprise one or more location-specific data elements defining a current or previous location of the electronic device, said location-specific data elements comprising one or more of GPS data, compass data and geolocation data.

6. The method of claim 1, wherein said step of electronically gathering one or more data elements comprises scanning a bar code placed within a user's environment, said bar code identifying selected data elements associated with a communicator or location associated with the electronic device.

7. The method of claim 1, further comprising a step of electronically storing speech output and/or software navigation locations made while operating in a determined communication context for subsequent use in making communicator-specific and/or location-specific message item suggestions for use when operating in the determined communication context.

8. An electronic device, comprising:
at least one electronic output device configured to display a user interface area for composing messages as visual output to a user;
at least one electronic input device configured to receive electronic input defining one or more data elements characterizing one or more of a communicator and location associated with the electronic device;
at least one processing device;
at least one memory comprising computer-readable instructions for execution by said at least one processing device, wherein said at least one processing device is configured to receive the one or more data elements characterizing the communicator and/or location associated with the electronic device, analyze selected ones of the one or more data elements to determine a communication context, wherein said communication context comprises a data structure that provides a profile defined by the analyzed data elements, process information identifying the communication context to make message item suggestions for potential use while the electronic device is operating in the determined communication context, and provide to a user the message item suggestions as an array of selectable output items on the at least one electronic output device.

9. The electronic device of claim 8, wherein the message item suggestions comprise one or more of vocabulary, words, phrases and symbols.

10. The electronic device of claim 8, wherein said electronic device comprises a speech generation device, and wherein said speech generation device further comprises a speaker for providing audio output of messages composed while using the speech generation device.

11. The electronic device of claim 8, wherein the data elements comprise one or more communicator-specific data elements defining a user or communication partner of the electronic device, said communicator-specific data elements comprising one or more of user specification data, speech content data, voice identification data and facial recognition data.

12. The electronic device of claim 8, wherein the data elements comprise one or more location-specific data elements defining a current or previous location of the electronic device, said location-specific data elements comprising one or more of GPS data, compass data and geolocation data.

13. The electronic device of claim 8, wherein said at least one electronic input device comprises a touchscreen or keyboard.

14. The electronic device of claim 8, wherein said at least one electronic input device comprises a bar code scanner.

15. The electronic device of claim 8, wherein said at least one processing device is further configured to store speech output and/or software navigation locations made while operating in a determined communication context for subsequent use in making communicator-specific and/or location-specific message item suggestions for use when operating in that determined communication context.

16. A computer readable medium comprising computer readable and executable instructions configured to control a processing device to implement acts of:
electronically gathering one or more data elements characterizing one or more of a communicator and location associated with an electronic device;
electronically analyzing selected ones of the one or more data elements to determine a communication context, wherein said communication context comprises a data structure that provides a profile defined by the analyzed data elements;
electronically processing information identifying the communication context to make message item suggestions for potential use while the electronic device is operating in the determined communication context; and
electronically providing to a user the message item suggestions as an array of selectable output items on a display component of the electronic device.

17. The computer readable medium of claim 16, wherein the message item suggestions comprise one or more of vocabulary, words, phrases and symbols.

18. The computer readable medium of claim 16, wherein said data elements comprise one or more communicator-specific data elements defining a user or communication partner of the electronic device, said communicator-specific data elements comprising one or more of user specification data, speech content data, voice identification data and facial recognition data.

19. The computer readable medium of claim 16, wherein said data elements comprise one or more location-specific data elements defining a current or previous location of the electronic device, said location-specific data elements comprising one or more of GPS data, compass data and geolocation data.

20. The computer readable medium of claim 16, wherein said computer readable and executable instructions further configure the processing device to electronically store speech output and/or software navigation locations made while operating in a determined communication context for subsequent use in making communicator-specific and/or language-specific message item suggestions for use when operating in that determined communication context.
